(19) United States
(12) Patent Application Publication
(10) Pub. No.: US 2003/0117426 A1
(43) Pub. Date: Jun. 26, 2003

(54) Methods and systems for exchanging information, such as information related to material substitutions and specification supersedures

(76) Inventor: Phyllis R. Budka, Niskayuna, NY (US)

Correspondence Address: PERKINS COIE LLP, PATENT-SEA, P.O. BOX 1247, SEATTLE, WA, 98111-1247, US

(21) Appl. No.: 10/032,210

(22) Filed: Dec. 21, 2001

(51) Int. Cl. G09G 5/00

(52) U.S. Cl. 345/703

(57) ABSTRACT

Methods and systems for providing up-to-date materials and processes information. In one embodiment, a computer-based system allows suppliers in a global supplier base to access current information about materials and processes used in the manufacture of parts and assemblies. Such information can include material substitutions and specification supersedures. In one aspect of this embodiment, the computer-based system allows a company that orders parts and assemblies from these suppliers to periodically update this information to ensure the suppliers have access to current information.

### TECHNICAL FIELD

The following disclosure relates generally to methods and systems for exchanging materials and processes information and, more particularly, to computer-implemented methods and systems for exchanging information related to material substitutions and material and process specification supersedures.

### BACKGROUND

Many companies that manufacture and sell complex machinery rely on outside suppliers to provide them with parts and assemblies for their products. These suppliers may be located in different countries around the globe, and can supply parts and assemblies ranging from basic mechanical componentry to complex semiconductor circuitry. When a company places an order with an outside supplier for parts and assemblies, the company typically uses engineering drawings to specify the technical requirements for the parts and assemblies. In addition to providing dimensional requirements that apply, these engineering drawings also specify the materials and processes to be used in the manufacture of the parts and assemblies. Materials and processes are generally specified on engineering drawings by drawing notes that reference corresponding industry specifications that describe the materials and processes in detail. A number of professional societies maintain such industry specifications. For example, the American Society for Testing and Materials maintains a comprehensive library of “ASTM” specifications for various metallic materials.

It is not uncommon for specifications used in the manufacturing of parts and assemblies to change over time. Such specifications would include material specifications and process specifications. One change might be for a material specification to be revised or updated to specify materials that are substitutable for the primary material associated with the specification. Another change might be for one specification (e.g., a material specification or a process specification) to be totally inactivated and superseded by another, different specification.

For example, material specifications are often revised to include acceptable substitute materials that demonstrate mechanical properties which meet the technical requirements of the original material and may be less expensive or more easily obtainable. In addition, domestic material specifications are often revised to include cross-references to equivalent foreign material specifications. Such cross-referencing enables a foreign supplier to procure local materials certified to local industry specifications that comply with the domestic specifications called out on engineering drawings.

Process specifications may also be revised or superseded for a number of different reasons. Consider, for example, a process specification for finishing a metallic surface. Occasionally, one of the chemicals called for in such a process specification may become prohibitively expensive or, alternatively, may be deemed hazardous by the applicable governing agency. In this situation, the process specification may be revised to call for a different chemical that may be less expensive or less hazardous. In other situations, the process specification may be superseded by a different specification that achieves an equivalent metallic finish using a different, but more advantageous, process.

Suppliers need to stay abreast of material substitutions and specification (e.g., material and process specification) supersedures for a number of reasons. For example, if a supplier is unaware that a particular process specification has been superseded, the supplier may inadvertently continue to manufacture parts that are rejectable for failure to comply with the current process specification. As another example, a foreign supplier may not have easy access to materials certified to the domestic specifications originally called out on the engineering drawings. The domestic material specifications, however, may have subsequently been revised to include cross-references to foreign material specifications for alternate materials that are available to the foreign supplier. Without having access to the revised material specifications, the foreign supplier would not be aware of the alternate materials, and may incur unnecessary expense acquiring the domestic materials called out on the engineering drawing.

Existing methods for providing information about specification supersedures have a number of shortcomings, and often involve the use of one or more unconnected, paper-based, documentation systems. One such method, for example, utilizes a first document that lists specifications in alpha-numeric order. Those process specifications that have been superseded include some sort of indicia, such as a “flag,” to indicate that the specification has been superseded. A second document lists the superseded specifications and the specifications that supersede them. A supplier or other party wishing to determine whether a particular specification has been superseded would begin by searching the first document to find the specification in question. If the specification was flagged as superseded, then the supplier would access the second document to ascertain the number of the superseding specification. After ascertaining the number, the supplier would then access an appropriate (often paper-based) repository to retrieve a copy of the applicable superseding specification. Existing methods for providing information about material substitutions are similar to the circuitous method described above for providing information about specification supersedures.

The shortcomings described above can make the process of obtaining information related to material substitutions and specification supersedures both time-consuming and error-prone. As a result, suppliers and other parties may elect not to investigate whether specifications called out on engineering drawings have been superseded or revised. Consequently, suppliers may deliver parts and assemblies that are unacceptable because they have been manufactured to superseded specifications. Furthermore, foreign suppliers may incur needless expense obtaining domestic materials when readily available local materials could have been used as acceptable substitutes. In light of the shortcomings associated with existing methods for providing materials and processes information, methods and systems for efficiently providing such information are desirable.

### BRIEF DESCRIPTION OF THE DRAWINGS

FIG. 1 is a block diagram illustrating components of a materials and processes information exchange system in one embodiment.

FIG. 2 is a diagram illustrating aspects of a display page for requesting materials and processes information in one embodiment.

FIG. 3 is a diagram illustrating aspects of a display page for providing material information in one embodiment.

FIG. 4 is a diagram illustrating aspects of a display page for providing specification information in one embodiment.

FIG. 5 is a flow diagram illustrating a routine for updating a database with material and/or process information in one embodiment.

FIG. 6 is a flow diagram illustrating a routine for providing material and/or process information in one embodiment.

FIG. 7 is a flow diagram illustrating a routine for sending an electronic version of a selected material or process specification to a user computer in one embodiment.

FIG. 8 is a flow diagram illustrating a routine for obtaining up-to-date material and/or process information in one embodiment.

FIG. 9 is a diagram illustrating aspects of a display page for receiving information related to a specification in one embodiment.

### DETAILED DESCRIPTION

The following disclosure describes methods and systems for providing up-to-date information about materials and processes. Companies often contract with outside suppliers to provide manufactured parts and assemblies. The manufacturing requirements for these parts and assemblies generally include the use of specific materials and manufacturing processes. It is not uncommon, however, for these materials to have allowable substitutes, often because they may be difficult for some suppliers to obtain. Similarly, these processes may be superseded by other processes found to be preferable for one reason or another. In either of these situations, it is advantageous for suppliers to obtain information regarding the material substitutions and the process specification supersedures so that they can be aware of material options and avoid inadvertently manufacturing parts and assemblies using superseded specifications. In one embodiment, the methods and systems described herein can be used to provide suppliers with this type of materials and processes information.

In one embodiment, an administrator of the system, such as a company that orders manufactured parts and assemblies from suppliers, uses a general-purpose computer, such as a personal computer, to update information in a material substitution database and a specification supersedure database. The updated information can include recently approved material substitutions and material specification cross-references, in addition to recently approved specification supersedures. In one aspect of this embodiment, the administrator updates these databases by accessing one or more user interface display pages from a web site and inputting the new information. This information is then sent via a communications link, such as the Internet, to a system server computer for storage in the appropriate databases.

In another embodiment, a user of the system, such as a supplier of manufactured parts and assemblies, operates a general-purpose computer to access one or more display pages from the web site and obtain the updated materials and processes information. For example, consider a supplier preparing to manufacture parts and assemblies for the ordering company in accordance with requirements called out on one or more engineering drawings. Before beginning the actual manufacturing process, the supplier may want to ensure that material is available that is certified to the material specifications on the engineering drawings. On some occasions, the supplier will not have access to such material. This occasion may arise when the supplier is located in a foreign country, in which case the supplier will likely have access to similar materials that are certified to foreign material specifications. In this situation, the supplier may need to know which foreign material specifications correspond to the domestic material specification called out on the engineering drawing. In other situations, a particular supplier may not have access to the specific type of material called out on the face of the engineering drawing, but may instead have access to a number of similar materials. In these situations, the supplier may be interested in finding out what, if any, material substitutions exist for the material called out on the engineering drawing. Similarly, the supplier may also want to be aware of any process specification supersedures before investing time and expense into manufacturing the parts and assemblies.

Accordingly, it will be advantageous to the supplier to obtain up-to-date information regarding the materials and processes called out on the engineering drawings. The supplier may do so using the methods and systems described herein by first accessing a user interface display page from the web site. On this user interface display page, the supplier enters a number or other alpha-numeric identifier that identifies the material or process specification of interest. By clicking on an appropriate button, the specification number is sent to the server computer, which retrieves updated information regarding the identified specification. The server computer then generates a display page containing this updated information and sends the display page back to the supplier via the communications link. This display page contains information such as whether substitute materials exist or whether the specification has been superseded. If substitute materials do exist, then such materials are identified. Similarly, if the specification has been superseded, then the superseding specification is also identified. If the supplier desires copies of the substitute material specifications or the superseding specifications, the supplier can obtain these by clicking on a corresponding item identifier on the display page. Thus, using the methods and systems of the present disclosure, a supplier can readily obtain up-to-date materials and processes information.

Certain embodiments and methods of the systems described for exchanging materials and processes information are described in the context of computer-executable instructions performed by a general-purpose computer, such as a personal computer. In one embodiment, for example, these computer-executable instructions are stored in a computer-readable medium, such as a floppy disk or CD-ROM. In other embodiments, instructions are stored on a server computer system and accessed via a communications link or computer network, such as an intranet or the Internet. Because the basic structures and functions related to computer-readable routines and corresponding computer implementation systems are well known, they have not been shown or described in detail here to avoid unnecessarily obscuring the described embodiments.

Although the following disclosure provides specific details for a thorough understanding of several embodiments of a materials and processes information exchange system, those of ordinary skill in the relevant art will understand that these embodiments may be practiced without some of the details provided. In other instances, it will be appreciated that the methods and systems described can include additional details without departing from the spirit or scope of the disclosed embodiments.

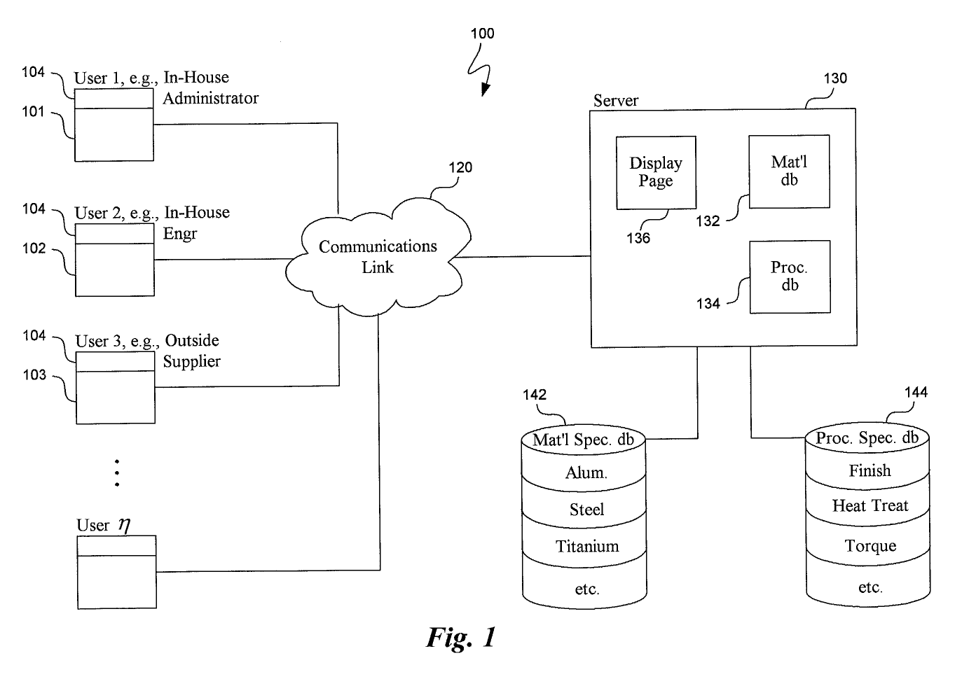

FIG. 1 is a block diagram illustrating components of a materials and processes information exchange system 100 in one embodiment. One or more user computers, such as user computers 101-103, are connected to a server computer 130 via a communications link 120. The user computers 101-103 are general-purpose computers, such as personal computers, and may include a central processing unit, memory devices, input devices (e.g., keyboard and pointing devices), output devices (e.g., display devices), and storage devices (e.g., disk drives). Memory and storage devices are computer-readable media that may contain computer instructions for implementing methods and systems, such as routines and display pages, in accordance with this disclosure. The user computers 101-103 may also include a browser module 104 that allows users to access and exchange data with the communications link 120, including web sites within the World Wide Web portion of the Internet. In a further aspect of this embodiment, the communications link 120 is a computer network, such as a local area network (LAN), an intranet, or the Internet.

In one aspect of this embodiment, the user computer 101 can be operated by a system administrator. The system administrator may be someone working in a company that contracts with outside suppliers for the manufacturing of parts and assemblies. For example, the administrator may be a person working in a Materials and Processes (M&P) group within the company. In a further aspect of this embodiment, the user computer 102 can be operated by an engineer in the same company (an “in-house” engineer) who utilizes the materials and processes information exchange system in the course of preparing engineering drawings for parts and assemblies. In yet another aspect of this embodiment, the user computer 103 can be operated by an outside supplier who has contracted with the company to provide the parts and assemblies in accordance with the engineering drawings prepared by the in-house engineer. Although possible users of the materials and processes information exchange system 100 have been described above for purposes of illustration, in other embodiments, the system may be utilized by other users without departing from the spirit or scope of the present disclosure.

In one embodiment, the server computer 130 includes a number of facilities for performing aspects of the materials and processes information exchange system 100. For example, the server computer 130 includes a display page component 136, a material database 132, and a process database 134. The display page component 136 contains display pages configured to convey and receive information about materials and processes, such as material substitutions and process specification supersedures. In one aspect of this embodiment, the display page component 136 generates such display pages using information retrieved from the material database 132 and the process database 134.

The material database 132 and the process database 134 are data stores for storing material information and process information, respectively. For example, in one embodiment, the material database 132 stores information about selected materials used in the manufacture of various parts and assemblies, such as mechanical parts and assemblies. For example, this information can include the form of the material, a common name and description of the material, and an identification of other materials that can be used as substitutes for the material. In addition, specifications for the substitute materials may be included that are categorized according to applicable region or country of origin.

In another embodiment, the process database 134 can include various information about manufacturing processes. These manufacturing processes can include many of the processes commonly associated with manufacturing parts and assemblies, such as processes for finishing parts, heat treating parts, installing fasteners in parts, etc. The process database 134 can include various information about such processes such as whether their corresponding specifications have been superseded and, if so, identification of the superseding specifications and the date the supersedure became effective.

In a further aspect of this embodiment, the server computer 130 is connected to a material specification database 142 and a process specification database 144. The material specification database 142 contains material specifications for various manufacturing materials. Similarly, the process specification database 144 contains process specifications for various manufacturing processes. Connection to the material specification database 142 and the process specification database 144 enables the server computer 130 to retrieve material specifications and process specifications in response to a request for them from one of the user computers 101-103.

The various facilities and functionality offered by the server computer 130 in conjunction with the other aspects of the materials and processes information exchange system 100 enable a company or other entity to maintain an up-to-date database of material substitutions and material and process specification supersedures. This system further enables users, such as in-house design engineers or outside suppliers, to access this information to either avail themselves of substitute materials or to ensure that they are not using superseded specifications.

As will be apparent to those of ordinary skill in the relevant art, the components and databases described above with reference to the server computer 130 are only representative of those that may be included in the materials and processes information exchange system 100. Accordingly, in other embodiments, more, fewer, or other components and databases may be included to meet the needs of a particular company in a particular industry. Those of ordinary skill in the relevant art will further appreciate how the concepts of the materials and processes information exchange system 100 can be implemented in various environments other than the Internet. For example, these concepts can be implemented in electronic mail environments in which the electronic mail messages may include the equivalent of a display page and associated exchanged information. Also, various communication channels other than the Internet may be used, such as a LAN, a wide area network, or a point-to-point dial-up connection. The concepts and attributes of the materials and processes information exchange system 100 may also be used in a single computer environment rather than a client/server environment, such as that depicted in FIG. 1.

Accordingly, the materials and processes information exchange system 100 may comprise any combination of hardware or software that can support these concepts. In particular, the server computer 130 may include multiple computers. Similarly, a client system, such as one or more of the user computers 101-103, may comprise any combination of hardware or software that interacts with the server computer 130 in accordance with this disclosure. Such client systems may include television-based systems and various other consumer products through which display pages may be accessed and utilized for the exchange of information.

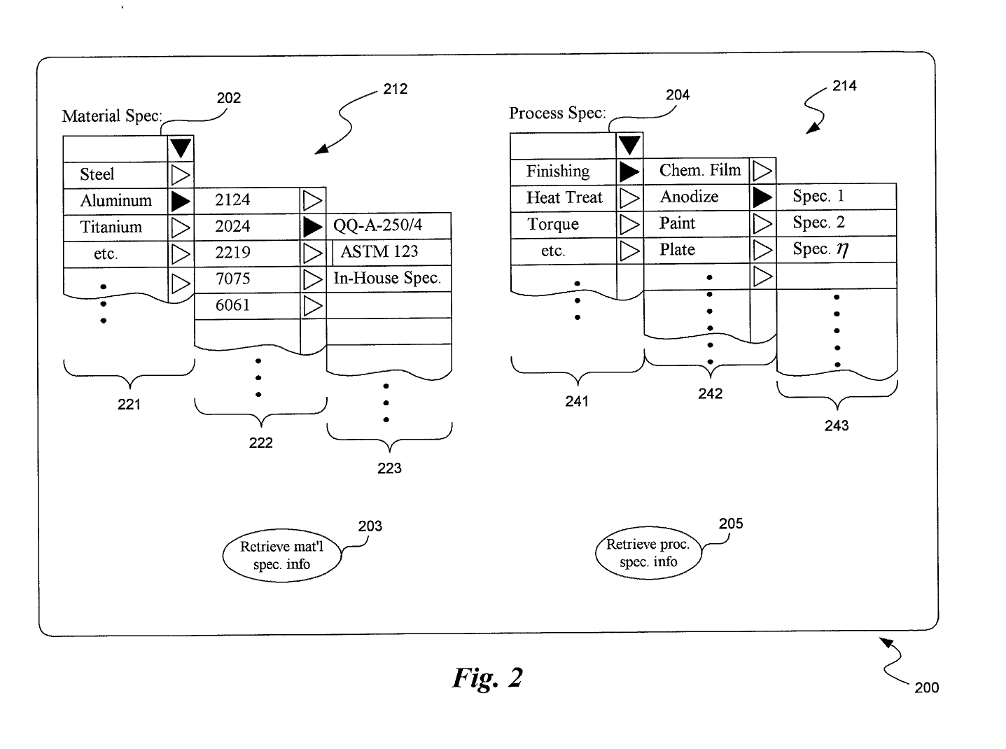

FIG. 2 is a diagram illustrating aspects of a display page 200 for requesting materials and processes information in one embodiment. In one aspect of this embodiment, the display page 200 includes a material specification identification field 202 and a process specification identification field 204. A user, desiring to obtain information about a particular material, such as possible substitutes for the material, enters the specification number corresponding to the material in the material specification identification field 202. The user can type this information into the field 202 using a conventional input device, such as a keyboard, or the user can utilize an associated material drop-down list 212. The drop-down list 212 includes a number of layers, such as a material layer 221, a heat treat layer 222, and a specification layer 223. The user selects a material specification using the drop-down list 212 by first dragging a pointing device over the desired material in the material layer 221, then dragging the pointing device over the desired heat treat in the heat treat layer 222, and then “clicking” the pointing device on the desired specification number (i.e., selecting the desired specification number) in the specification layer 223. After the user has entered the material specification of interest in the field 202, the user may click an associated retrieve button 203 to retrieve current information about the material specification.

The user can enter a process specification of interest in the process specification identification field 204 using steps that are substantially similar to those described above for material specifications. That is, the user can type the desired process specification in the field 204 using a conventional keyboard input device, or the user can search through an associated process specification dropdown list 214. The process specification drop-down list 214 includes a general process layer 241, a detail process layer 242, and a process specification layer 243. Accordingly, the user drags the pointing device over the desired general process in the general process layer 241 to bring up associated detail processes in the detail process layer 242. The user then positions the pointing device on the desired detail process to bring up an associated list of process specifications in the process specification layer 243. By clicking on the desired process specification, the desired process specification will be automatically entered in the field 204. After the user has entered the process specification of interest in the field 204, the user can click an associated retrieve button 205 to retrieve current information about the process specification.

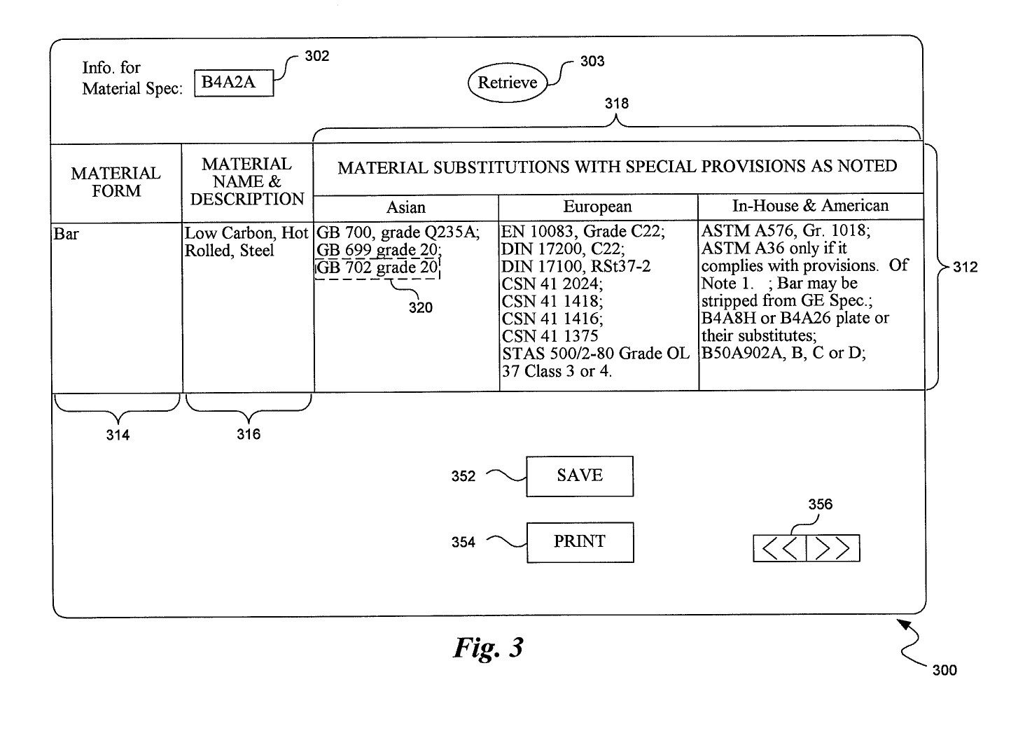

FIG. 3 is a diagram illustrating aspects of a display page 300 for providing material information in one embodiment. In one aspect of this embodiment, the display page 300 includes a material specification identifier 302 and a material information portion 312. The material information portion 312 contains current information relating to the material specification identified in field 302, and includes a material form column 314, a material name and description column 316, and a material substitution column 318. In the embodiment illustrated in FIG. 3, the material specification B4A2A identified in field 302 corresponds to low carbon, hot rolled steel in bar form. In a further aspect of this embodiment, the material specifications shown in the material substitution column 318 can be used as substitutes for the material specification B4A2A identified in field 302. In the illustrated embodiment, the material substitution column 318 includes substitute foreign specifications such as substitute Asian material specifications and substitute European material specifications, in addition to substitute domestic specifications such as substitute American material specifications and substitute material specifications generated by the contracting company. For example, the display page 300 shows a plurality of substitute specifications available to the supplier for material specification B4A2A. If the supplier is an Asian national, then the supplier can pick one of the Asian specifications. Similarly, if the supplier is a European national, the supplier may elect to choose from the list of European specifications.

The display page 300 offers the user a number of options. For example, if the user wishes to retrieve a copy of the original material specification, the user may do so by clicking a retrieve button 303. Similarly, if the user desires to retrieve a copy of one of the substitute material specifications, the user may do so by clicking on the name of the desired specification. For example, to obtain a copy of Asian specification “GB 702 grade 20,” the user clicks on field 320.

The display page 300 further includes additional functionalities commonly associated with user interface display pages. For example, the display page 300 includes a save button 352, a print button 354, and a forward/backward selector 356. Clicking the save button 352 allows the user to save the display page 300 to an electronic storage medium, such as a CD-ROM or floppy disk. Clicking the print button 354 allows the user to print a hard copy of the display page using an associated printer. The user may also jump to a previous or subsequent display page by clicking the appropriate portion of the forward/backward selector 356.

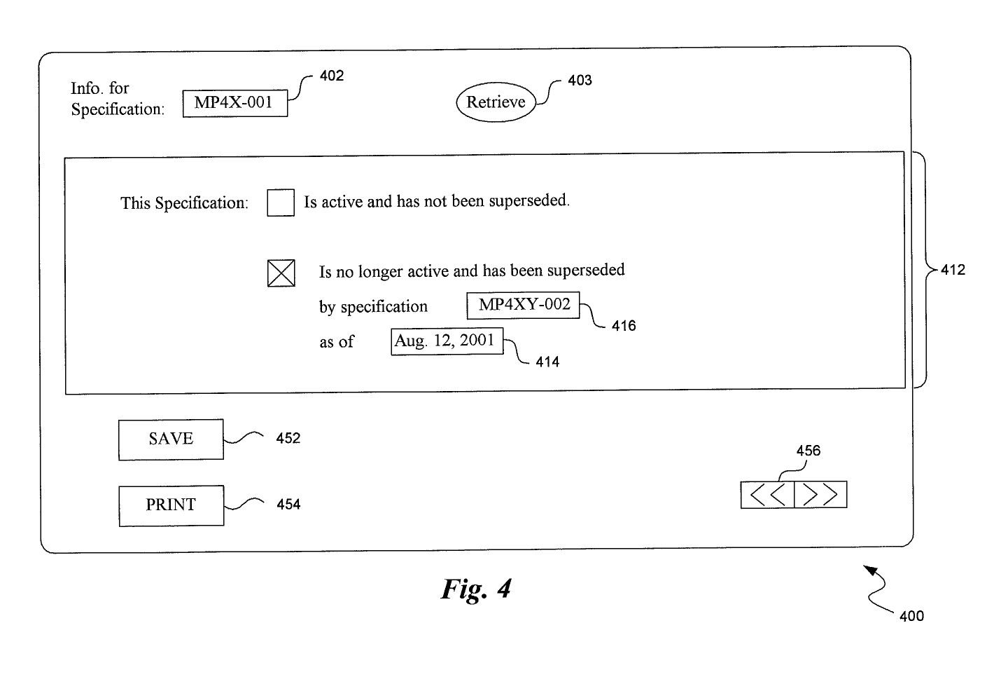

FIG. 4 is a diagram illustrating aspects of a display page 400 for providing specification information in one embodiment. In one aspect of this embodiment, the display page 400 includes a specification identifier field 402 and a specification information portion 412. The specification information portion 412 includes current information relating to the status of the specification identified in field 402. For example, the specification information portion 412 includes information indicating whether the specification identified in field 402 has or has not been superseded. The specification information portion 412 further includes a superseding specification identifier field 416 and a corresponding date field 414. In the embodiment illustrated in FIG. 4, for example, the display page 400 indicates that specification MP4X-001 identified in field 402 is no longer active and has been superseded by specification MP4XY-002 as of Aug. 12, 2001.

The specification information display page 400 includes a number of other functionalities to accommodate the user. For example, the display page 400 includes a save button 452, a print button 454, and a forward/backward selector 456. The save button 452, the print button 454, and the forward/backward selector 456 all operate in a substantially similar manner as their counterparts described above in accordance with FIG. 3.

Those of ordinary skill in the relevant art will understand that the display page functionalities described above with reference to the display pages 200, 300, and 400 are only representative embodiments. Accordingly, other types of display page functionality for conveying information about material substitutions or specification supersedures can be included in these display pages without departing from the present disclosure.

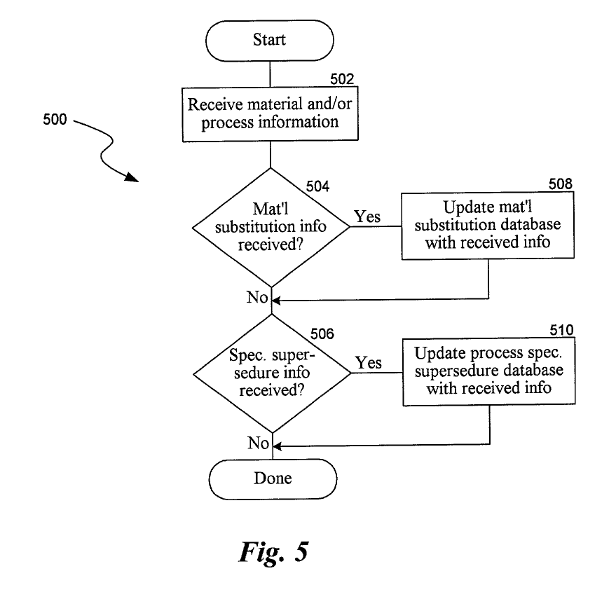

FIG. 5 is a flow diagram illustrating a routine 500 for updating a database with material and/or process information in one embodiment. In one aspect of this embodiment, the routine 500 can be executed by the server computer 130 of FIG. 1 in accordance with computer-readable instructions stored on a computer-readable medium, such as a CD-ROM. In a further aspect of this embodiment, the routine can be executed by the server computer 130 in response to information received from the user computer 101. This information may be sent from the user computer 101 for the purpose of updating the material database 132 with material substitution information, or for updating the material database 132 or the process database 134 with specification supersedure information.

In block 502, the routine receives material and/or process information from a user computer. In decision block 504, the routine determines whether the received information includes material substitution information. If no material substitution information is included, then the routine proceeds to decision block 506. If material substitution information is included, then in block 508, the routine stores the material substitution information in a suitable database, such as the material database 132 shown in FIG. 1, before proceeding to decision block 506.

In decision block 506, the routine determines whether the received information includes specification supersedure information. If no specification supersedure information is included, then the routine is complete. If specification supersedure information is included, then in block 510, the routine stores the specification supersedure information in a suitable database. For example, if the supersedure information relates to a material specification, then the information can be stored in the material database 132. Conversely, if the supersedure information relates to a process specification, then the information can be stored in the process database 134. After the received information is stored, the routine 500 is complete.

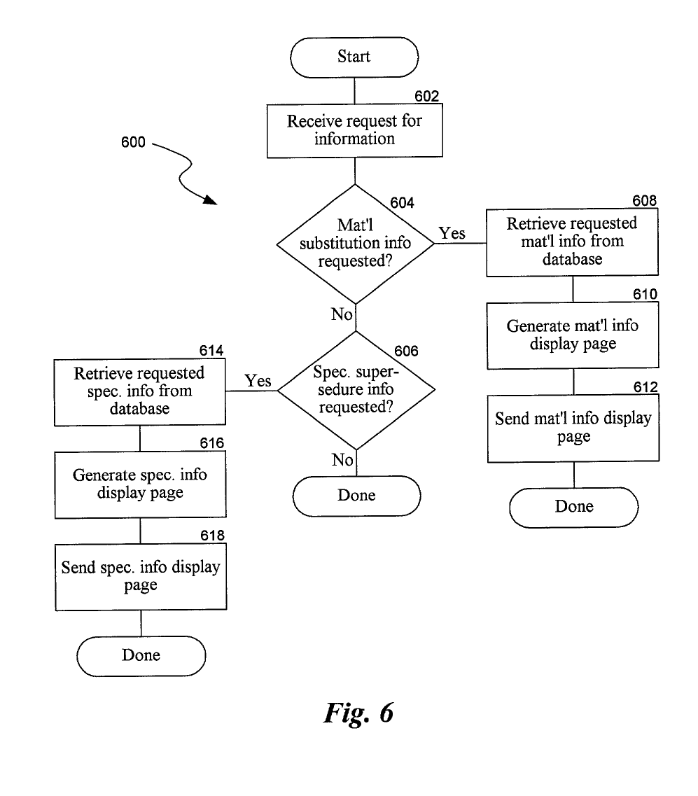

FIG. 6 is a flow diagram illustrating a routine 600 for providing material and/or process information in one embodiment. In one aspect of this embodiment, the routine can be executed by the server computer 130 of FIG. 1 in response to a request for information from the user computer 103. In block 602, the routine receives a request for information, such as a request for material substitution or specification supersedure information. In decision block 604, the routine determines whether the received request included a request for material substitution information. If material substitution information was requested, then in block 608, the routine retrieves the requested material substitution information from a database, such as the material database 132 shown in FIG. 1. In block 610, the routine generates a material information display page using the retrieved material substitution information. In block 612, the routine sends the generated display page to the user computer that requested the information, such as the user computer 103 of FIG. 1, and the routine is complete.

Returning to decision block 604, if material substitution information was not requested, then the routine proceeds to decision block 606. In decision block 606, the routine determines whether the received request included a request for specification supersedure information. If such information was not requested, then the routine 600 is complete. If the received request did include a request for specification supersedure information, then in block 614, the routine retrieves the requested supersedure information from a database, such as the process database 134 or the material database 132 shown in FIG. 1. In block 616, the routine generates a specification information display page using the retrieved specification information. In block 618, the routine sends the generated display page to the user computer that requested the information, for example, the user computer 103 of FIG. 1. After the display page has been sent to the user computer, the routine is complete.

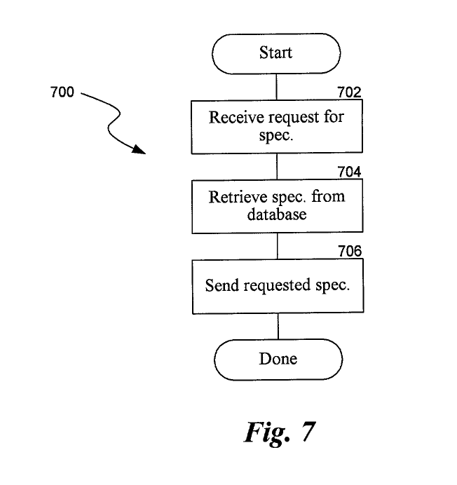

FIG. 7 is a flow diagram illustrating a routine 700 for sending an electronic version of a selected material or process specification to a user computer in one embodiment. In one aspect of this embodiment, the routine 700 can be executed by the server computer 130 of FIG. 1 in response to a request from a user computer, such as the user computer 102 or 103, for a particular specification. In a further aspect of this embodiment, a user, such as a supplier or an in-house engineer, can initiate the request for a particular specification by clicking on the name of the desired specification on a corresponding display page, such as the display page 300 or 400 described above in accordance with FIG. 3 or 4, respectively.

In block 702, the server computer 130 receives a request from the user computer for a specification, such as a material specification or a process specification. In block 704, the routine retrieves the requested specification from a database, such as the material specification database 142 or the process specification database 144 shown in FIG. 1. In block 706, the routine sends the retrieved specification to the user computer and the routine is complete.

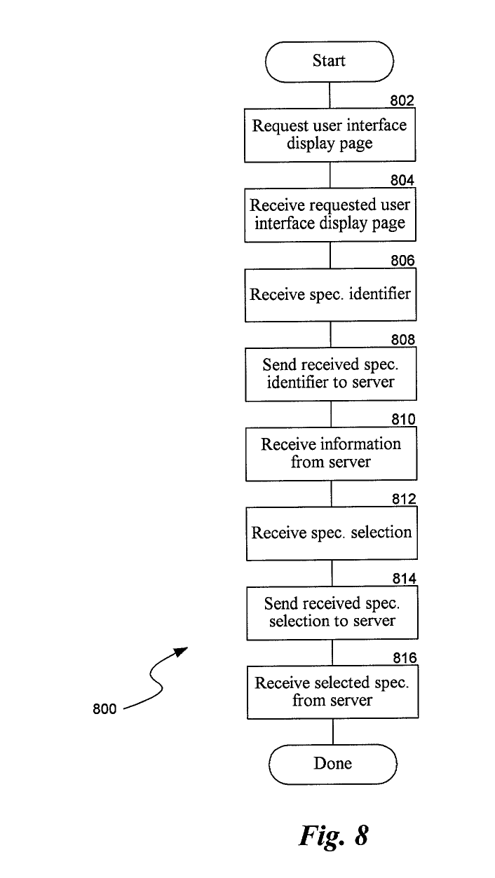

FIG. 8 is a flow diagram illustrating a routine 800 for obtaining up-to-date material and/or process information in one embodiment. In one aspect of this embodiment, the routine 800 can be executed by a user computer, such as the user computer 103 of FIG. 1, in response to inputs received from a user, such as an outside supplier. In block 802, the routine requests a user interface display page from the server computer 130 of FIG. 1. In block 804, the routine receives the requested user interface display page. In block 806, the routine receives a specification identifier. In one embodiment, the received specification identifier is an alpha-numeric identifier corresponding to a material specification. In another embodiment, the received specification identifier is an alpha-numeric identifier corresponding to a process specification. In block 808, the routine sends the received specification identifier to the server computer 130.

In block 810, the routine receives information from the server computer 130 relating to the specification identified by the specification identifier. In one embodiment, this information can include material substitution information, such as information identifying a material that is substitutable for the specified material. In another embodiment, this information can include specification supersedure information, such as information identifying a specification that has superseded the specification identified by the specification identifier.

In block 812, the routine receives a specification selection. In one embodiment, this selection corresponds to an input from a user selecting one of the material or process specifications included in the information received from the server computer 130. In block 814, the routine sends the received specification selection to the server computer 130. In block 816, the routine receives the selected specification from the server computer 130 and the routine is complete.

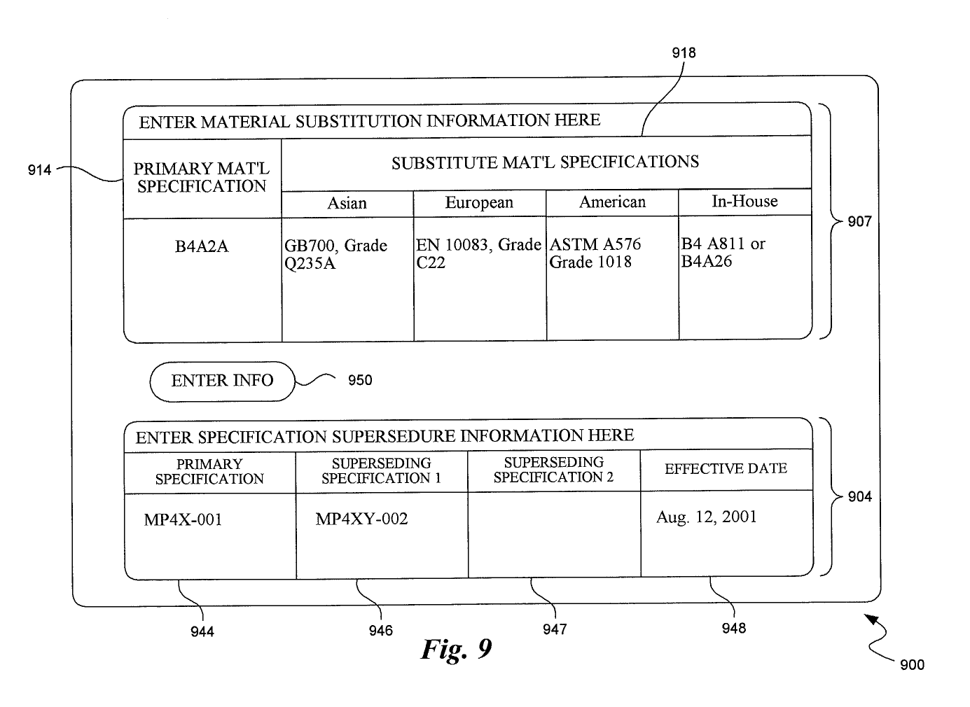

FIG. 9 is a diagram illustrating aspects of a display page 900 configured to receive information related to a specification, such as a material specification or a process specification, in one embodiment. In one aspect of this embodiment, the display page 900 includes a material substitution portion 902 and a specification supersedure portion 904. The material substitution portion 902 includes a primary material specification field 914 and one or more substitute material specification fields 918. In a further aspect of this embodiment, the substitute material specification fields 918 can include fields for substitute Asian specifications, substitute European specifications, substitute American specifications, and substitute in-house specifications associated with the administrating company. Accordingly, a user, such as a system administrator working for a company that orders manufactured parts and assemblies from outside suppliers, can access the display page 900 and enter a specification identifier associated with a primary material in field 914, and then enter specification identifiers associated with substitute materials in fields 918.

In one embodiment, the specification supersedure information portion 904 includes a primary specification field 944, a first superseding specification field 946, a second superseding specification field 947, and an effective date field 948. Accordingly, the user can enter the specification identifier associated with a primary specification in the primary specification field 944. The user may then identify superseding specifications by entering associated identifiers in the superseding specification fields 946 and 947. Similarly, the user can indicate the date on which the supersedure is to take effect by entering such date in the effective date field 948.

Accordingly, a user, such as the system administrator, can access the display page 900 and enter up-to-date information regarding material substitutions and specification supersedures. Upon entering this information, the user can send this information to an appropriate database, such as the material database 132 or the process database 134 on the serving computer 130 of FIG. 1, by clicking the enter button 950.

It will be appreciated from the foregoing that although specific embodiments of the materials and processes information exchange system have been described for purposes of illustration, various modifications may be made without departing from the spirit or scope of the invention. For example, in one embodiment, various filters can be employed to control the materials and processes information provided. In one aspect of this embodiment, each supplier will be associated with a country or region. In a further aspect of this embodiment, each substitute material and superseding specification will also be associated with a country or region. When the supplier requests information, such as information regarding substitute materials, only those substitute materials associated with the country or region the supplier is from will be sent to the supplier. Similarly, if a supplier requests specification supersede information, then only superseding specifications associated with the supplier's country or region will be sent to the supplier.

Other filters can be employed consistent with this disclosure. For example, process specifications can be filtered based on which country the supplier is from. If a particular process is regulated in a particular country or region, then that process specification will not be sent to a supplier from that country or region. In yet another filter embodiment, when a supplier requests information about a particular substitute material, they will also be provided with additional information that includes a cross-reference to process specifications which apply to the substitute material.

Further, rather than requiring the supplier to request update information about a particular material or specification, in an alternate embodiment, an electronic message, such as an email message, is automatically sent to selected suppliers every time the company updates a specification. This message will alert the suppliers that the corresponding specification has been updated, and may provide a link to the updated information.

Other embodiments also exist for the display pages described above. For example, one or more of these display pages may include text boxes wherein the suppliers may enter comments about a particular material or process. These comments may then be stored in a database and retrieved the next time a user, such as another supplier, requests information regarding the corresponding material or process.

Further, although the methods and systems have been described in the context of suppliers of parts and assemblies, such as suppliers of mechanical parts and assemblies, it will be understood by those of ordinary skill in the relevant art that the methods and systems disclosed herein are equally well suited for other types of suppliers in other types of industries. These and other changes may be made to the invention in light of the above-detailed description.

While certain aspects of the invention are presented below in certain claim forms, the inventors nevertheless contemplate additional embodiments of the invention consistent with other claim forms. Accordingly, the inventors reserve the right to add additional claims after filing the application to pursue such additional claim forms for all aspects of the invention as contemplated. Further, the terms used in the following claims should not be construed to limit the invention to the specific embodiments disclosed in the specification or claims, but, instead, should be construed to include all materials and processes information exchange systems that operate in accordance with the claims. The scope of the invention is therefore not limited by this disclosure, but, instead, the scope of the invention is to be determined entirely by the following claims.

I claim:

1. A method in a computer system for providing information related to materials for manufacturing parts and assemblies, the method comprising:
receiving a first request for a first display page from a first computer;
in response to the received first request, providing the first display page to the first computer, the first display page being configured to receive information related to first and second materials, the second material being substitutable for the first material;
receiving the information related to first and second materials from the first computer;
storing the received information;
receiving a second request for a second display page from a second computer; and
in response to the received second request,
retrieving at least a portion of the stored information;
generating the second display page, the second display page containing at least a portion of the retrieved information; and
providing the second display page to the second computer.

2. The method of claim 1 wherein the first computer is located in a first country and the second computer is located in a second country.

3. The method of claim 1 wherein the first display page is configured to receive a first specification identifier identifying a first specification associated with the first material and a second specification identifier identifying a second specification associated with the second material.

4. The method of claim 3 wherein the second display page contains the first specification identifier and the second specification identifier.

5. The method of claim 4 wherein the second display page contains a material name and a material form, the material name and the material form being associated with the first material.

6. The method of claim 1 wherein the second display page contains a first specification identifier identifying a first specification associated with the first material and a second specification identifier identifying a second specification associated with the second material, wherein the first specification identifier is associated with a first geographical region and the second specification identifier is associated with a second geographical region.

7. The method of claim 6 wherein the first geographical region is the U.S.A. and the second geographical region is Asia.

8. The method of claim 6 wherein the first geographical region is the U.S.A. and the second geographical region is Europe.

9. The method of claim 1 wherein the second display page contains a first specification identifier identifying a first specification associated with the first material and a second specification identifier identifying a second specification associated with the second material, wherein the first specification identifier is associated with a first country and the second specification identifier is associated with a second country.

10. The method of claim 1 further comprising:
receiving a third request for a third display page from the second computer; and
in response to the received third request,
retrieving a material specification, the material specification relating to the second material;
generating the third display page, the third display page containing at least a portion of the retrieved material specification; and
providing the third display page to the second computer.

11. The method of claim 10 wherein the received information is stored in a first database and the at least a portion of the stored information is retrieved from the first database, and wherein the material specification is retrieved from a second database, the second database being different than the first database.

12. The method of claim 10 wherein the first computer is located in a first country and the second and third computers are located in a second country.

13. The method of claim 10 wherein:
the first display page is configured to receive a first specification identifier identifying a first specification associated with the first material and a second specification identifier identifying a second specification associated with the second material;
the second display page contains the first specification identifier and the second specification identifier; and
the third display page contains at least a portion of the second specification.

14. The method of claim 13 wherein the second display page contains a material name and a material form, the material name and the material form being associated with the first material.

15. The method of claim 10 wherein the second display page contains a first specification identifier identifying a first specification associated with the first material and a second specification identifier identifying a second specification associated with the second material, wherein the first specification identifier is associated with a first geographical region and the second specification identifier is associated with a second geographical region.

16. The method of claim 15 wherein the first geographical region is the U.S.A. and the second geographical region is Asia.

17. The method of claim 15 wherein the first geographical region is the U.S.A. and the second geographical region is Europe.

18. A method in a computer system for providing information related to specifications usable in connection with manufacturing, the method comprising:
receiving a first request for a first display page from a first computer;
in response to the received first request, providing the first display page to the first computer, the first display page being configured to receive information related to first and second specifications, the second specification superseding the first specification;
receiving the information related to the first and second specifications from the first computer;
storing the received information;
receiving a second request for a second display page from a second computer; and
in response to the received second request,
retrieving at least a portion of the stored information;
generating the second display page, the second display page containing at least a portion of the retrieved information; and
providing the second display page to the second computer.

19. The method of claim 18 wherein the first computer is located in a first country and the second computer is located in a second country.

20. The method of claim 18 wherein the first display page is configured to receive a first specification identifier identifying the first specification and a second specification identifier identifying the second specification.

21. The method of claim 18 wherein:
the first display page is configured to receive a first specification identifier identifying the first specification and a second specification identifier identifying the second specification; and
the second display page contains the first specification identifier and the second specification identifier.

22. The method of claim 21 wherein the second display page contains a date, the date defining when the first specification becomes inactive and the second specification becomes active.

23. The method of claim 18 wherein the second display page contains a first specification identifier identifying the first specification and a second specification identifier identifying the second specification, wherein the first specification identifier is associated with a first geographical region and the second specification identifier is associated with a second geographical region.

24. The method of claim 18 further comprising:
receiving a third request for a third display page from the second computer; and
in response to the received third request,
retrieving at least a portion of the second specification;
generating the third display page, the third display page containing at least a portion of the retrieved second specification; and
providing the third display page to the second computer.

25. The method of claim 24 wherein the received information is stored in a first database and the at least a portion of the stored information is retrieved from the first database, and wherein the at least a portion of the second specification is retrieved from a second database.

26. The method of claim 24 wherein the first computer is located in a first country and the second and third computers are located in a second country.

27. The method of claim 24 wherein: the first display page is configured to receive a first specification identifier identifying the first specification and a second specification identifier identifying a second specification; and the second display page contains the first specification identifier and the second specification identifier.

28. The method of claim 24 wherein the second display page contains a first specification identifier identifying the first specification and a second specification identifier identifying the second specification, wherein the first specification identifier is associated with a first geographical region and the second specification identifier is associated with a second geographical region.

29. A method in a computer system for providing information related to domestic specifications usable in connection with parts and assemblies provided by a foreign supplier for a domestic company, the method comprising:
receiving a first request for a first display page from a first computer, the first computer being associated with the domestic company;
in response to the received first request, providing the first display page to the first computer, the first display page being configured to receive information related to a first material specification or a first process specification;
receiving the information related to the first material specification or the first process specification from the first user computer;
storing the received information in a database;
receiving a second request for a second display page from a second computer, the second computer being associated with the foreign supplier; and
in response to the received second request,
retrieving at least a portion of the stored information from the database;
generating the second display page, the second display page containing at least a portion of the stored information; and
providing the second display page to the second computer.

30. The method of claim 29 wherein the first display page is configured to receive information related to the first material specification, wherein the first material specification is associated with a first material, and wherein the received information includes information related to a second material specification, the second material specification being associated with a second material that is substitutable for the first material.

31. The method of claim 29 wherein the first display page is configured to receive information related to the first material specification, and wherein the received information includes information related to a second material specification, the second material specification superseding the first material specification.

32. The method of claim 29 wherein the first display page is configured to receive information related to the first process specification, and wherein the received information includes information related to a second process specification, the second process specification superseding the first process specification.

33. The method of claim 29 wherein the first computer is located in a first country and the second computer is located in a second country.

34. The method of claim 29 wherein the first display page is configured to receive a first specification identifier identifying the first material specification and a second specification identifier identifying a second material specification, the first material specification being associated with a first material and the second material specification being associated with a second material that is substitutable for the first material.

35. The method of claim 29 wherein:
the first display page is configured to receive a first specification identifier identifying the first material specification and a second specification identifier identifying a second material specification, the first material specification being associated with a first material and the second material specification being associated with a second material that is substitutable for the first material; and
the second display page contains the first specification identifier and the second specification identifier.

36. The method of claim 29 wherein the first display page is configured to receive a first specification identifier identifying the first process specification and a second specification identifier identifying a second process specification, the second process specification superseding the first process specification.

37. The method of claim 29 wherein:
the first display page is configured to receive a first specification identifier identifying the first process specification and a second specification identifier identifying a second process specification, the second process specification superseding the first process specification; and
the second display page contains the first specification identifier and the second specification identifier.

38. A method in a computer system for obtaining information related to a specification usable in connection with manufacturing from a server computer, the method comprising:
requesting a first display page from the server computer;
in response to the request, receiving the first display page from the server computer, the first display page being configured to receive at least one specification identifier;
receiving from a user a first specification identifier, the first specification identifier identifying a first specification;
sending the first specification identifier to the server computer;
in response to sending the first specification identifier, receiving a second display page from the server computer, the second display page containing a second specification identifier, the second specification identifier identifying a second specification that relates to the first specification.

39. The method of claim 38 wherein the first specification is associated with a first material and the second specification is associated with a second material that is substitutable for the first material.

40. The method of claim 38 wherein the first specification is associated with a first geographical region and the second specification is associated with a second geographical region.

41. The method of claim 40 wherein the first geographical region is the U.S.A. and the second geographical region is Asia.

42. The method of claim 40 wherein the first geographical region is the U.S.A. and the second geographical region is Europe.

43. The method of claim 38 wherein the second specification supersedes the first specification.

44. The method of claim 43 wherein the first and second specifications are process specifications.

45. A computer system for providing information related to domestic specifications usable in connection with parts and assemblies provided by a foreign supplier for a domestic company, the computer system comprising:
means for receiving a first request for a first display page from a first computer, the first computer being associated with the domestic company;
means for providing the first display page to the first computer in response to the received first request, the first display page being configured to receive information related to a first material specification or a first process specification;
means for receiving the information related to the first material specification or the first process specification from the first user computer;
means for storing the received information in a database;
means for receiving a second request for a second display page from a second computer, the second computer being associated with the foreign supplier;
means for retrieving at least a portion of the stored information from the database in response to the received second request;
means for generating the second display page in response to the received second request, the second display page containing at least a portion of the stored information; and
means for providing the second display page to the second computer in response to the received second request.

46. The computer system of claim 45 wherein the first display page is configured to receive information related to the first material specification, wherein the first material specification is associated with a first material, and wherein the received information includes information related to a second material specification, the second material specification being associated with a second material that is substitutable for the first material.

47. The computer system of claim 45 wherein the first display page is configured to receive information related to the first material specification, and wherein the received information includes information related to a second material specification, the second material specification superseding the first material specification.

48. The computer system of claim 45 wherein the first display page is configured to receive information related to the first process specification, and wherein the received information includes information related to a second process specification, the second process specification superseding the first process specification.

49. The computer system of claim 45 wherein the first computer is located in a first country and the second computer is located in a second country.

50. The computer system of claim 45 wherein the first display page is configured to receive a first specification identifier identifying the first material specification and a second specification identifier identifying a second material specification, the first material specification being associated with a first material and the second material specification being associated with a second material that is substitutable for the first material.

51. The computer system of claim 45 wherein:
the first display page is configured to receive a first specification identifier identifying the first material specification and a second specification identifier identifying a second material specification, the first material specification being associated with a first material and the second material specification being associated with a second material that is substitutable for the first material; and
the second display page contains the first specification identifier and the second specification identifier.

52. The computer system of claim 45 wherein the first display page is configured to receive a first specification identifier identifying the first process specification and a second specification identifier identifying a second process specification, the second process specification superseding the first process specification.

53. The computer system of claim 45 wherein:
the first display page is configured to receive a first specification identifier identifying the first process specification and a second specification identifier identifying a second process specification, the second process specification superseding the first process specification; and
the second display page contains the first specification identifier and the second specification identifier.

54. A computer-readable medium whose contents cause a computer system to provide information related to a specification usable in connection with manufacturing, the information being provided by a method comprising:
receiving a first request for a first display page from a first computer;
in response to the received first request, providing the first display page to the first computer, the first display page being configured to receive information related to a first material specification or a first process specification;
receiving the information related to the first material specification or the first process specification from the first user computer;
storing the received information in a database;
receiving a second request for a second display page from a second computer; and
in response to the received second request,
retrieving at least a portion of the stored information from the database;
generating the second display page, the second display page containing at least a portion of the stored information; and
providing the second display page to the second computer.

55. The computer-readable medium of claim 54 wherein the first display page is configured to receive information related to the first material specification, wherein the first material specification is associated with a first material, and wherein the received information includes information related to a second material specification, the second material specification being associated with a second material that is substitutable for the first material.

56. The computer-readable medium of claim 54 wherein the first display page is configured to receive information related to the first material specification, and wherein the received information includes information related to a second material specification, the second material specification superseding the first material specification.

57. The computer-readable medium of claim 54 wherein the first display page is configured to receive information related to the first process specification, and wherein the received information includes information related to a second process specification, the second process specification superseding the first process specification.

58. The computer-readable medium of claim 54 wherein the first computer is located in a first country and the second computer is located in a second country.

59. A computer-readable medium containing a display page configured to provide information related to a material substitution, the display page comprising:
a material specification identifier field for identifying a first material specification associated with a first material; and
a material information portion, the material information portion providing information related to the first material including a second material specification, the second material specification associated with a second material, the second material being substitutable for the first material.

60. The computer-readable medium of claim 59 wherein the material information portion further includes:
a form of the first material; and
a common name associated with the first material.

61. The computer-readable medium of claim 59 wherein the material information portion further includes:
a form of the first material;
a common name associated with the first material; and
a third material specification, the third material specification associated with a third material, the third material being substitutable for the first material.

62. The computer-readable medium of claim 59 wherein the first material specification is associated with a first geographical region and the second material specification is associated with a second geographical region.

63. The computer-readable medium of claim 62 wherein the first material specification is associated with the U.S.A. a nd the second material specification is associated with Asia.

64. The computer-readable medium of claim 59 wherein the material information portion further includes a third material specification, the third material specification associated with a third material, the third material being substitutable for the first material, wherein the first material specification is associated with a first geographical region, the second material specification is associated with a second geographical region, and the third material specification is associated with a third geographical region.

65. The computer-readable medium of claim 64 wherein the first geographical region is the U.S.A., the second geographical region is Asia, and the third geographical region is Europe.

66. A computer-readable medium containing a display page configured to provide information related to a specification, the display page comprising:
a specification identifier field for identifying a first specification; and
a specification information portion, the specification information portion providing information related to the first specification including:
an indication of whether the first specification has been superseded; and
when the first specification has been superseded, a second specification, the second specification superseding the first specification.

67. The computer-readable medium of claim 66 further comprising:
when the first specification has been superseded, a date defining when the second specification superseded the first specification.

68. The computer-readable medium of claim 66 wherein the first and second specifications are material specifications.

69. A method for providing information related to a first material usable in connection with parts and assemblies provided by a supplier for a company, the method comprising:
receiving from the company an indication of a second material that is substitutable for the first material;
storing a mapping between the first material and the second material;
receiving from the supplier a request for information relating to the first material;
in response to receiving the request,
retrieving the stored mapping between the first and second materials; and
providing an indication that the second material is substitutable for the first material.

70. The method of claim 69 when the second material is associated with a country and wherein the second material is substitutable for the first material only when the supplier is located in the country.

71. The method of claim 69 further comprising receiving an indication of multiple materials that are substitutable for the first material, each of the substitutable materials being associated with a country.

72. The method of claim 71 further comprising:
determining a country associated with the supplier; and
filtering the substitutable materials based on the country associated with the supplier.

73. A method for providing information related to a first specification usable in connection with parts and assemblies provided by a supplier for a company, the method comprising:
receiving from the company an indication of a second specification that supersedes the first specification;
storing a mapping between the first specification and the second specification;
receiving from the supplier a request for information relating to the first specification;
in response to receiving the request,
retrieving the stored mapping between the first and second specifications; and
providing an indication that the second specification is substitutable for the first specification.

74. The method of claim 73 when the second specification is associated with a country and wherein the second specification supersedes the first specification only when the supplier is located in the country.

75. The method of claim 73 further comprising receiving an indication of multiple specifications that supersede the first specification, each of the superseding specifications being associated with a country.

76. The method of claim 75 further comprising:
determining a country associated with the supplier; and
filtering the superseding specifications based on the country associated with the supplier.
